(19) United States
(12) Patent Application Publication
(10) Pub. No.: US 2025/0101622 A1
(43) Pub. Date: Mar. 27, 2025

(54) APPARATUS AND METHOD FOR PRODUCING LI METAL

(71) Applicant: HYDRO-QUÉBEC, Montréal (CA)

(72) Inventors: Kamyab AMOUZEGAR, Mont-Royal (CA); François ALLARD, Hérouxville (CA); Pascal CHAMPAGNE, Trois-Rivières (CA); Patrick BOUCHARD, Shawinigan (CA); Dominic LEBLANC, Bécancour (CA); Bernard TOUGAS, Saint-Maurice (CA); Nancy TURCOTTE, Saint-Tite (CA)

(21) Appl. No.: 18/728,758

(22) PCT Filed: Jan. 12, 2023
(86) PCT No.: PCT/CA2023/050030

§ 371 Date: Jul. 12, 2024

Related U.S. Application Data
(60) Provisional application No. 63/299,114, filed on Jan. 13, 2022.

(51) Int. Cl. C25C 3/02; B01D 17/02; C25C 7/06

(52) U.S. Cl. CPC C25C 3/02; B01D 17/0217; C25C 7/06

(57) ABSTRACT

There are provided an apparatus and a method for producing lithium metal by electrolysis of LiCl in a diaphragmless electrolytic cell. The method and apparatus of the invention make use of a liquid-liquid separator which is at least one film coalescer or at least one centrifugal separator to coalesce or separate lithium metal from the Li metal/electrolysis medium mixture produced in the electrolytic cell. There is also provided a method for producing lithium metal from Li₂O in an electrolytic cell, the method comprising feeding Li₂O or feeding LiCl produced from Li₂O to the electrolytic cell.

### CROSS REFERENCE TO RELATED APPLICATIONS

This application claims benefit, under 35 U.S.C. § 119(e), of U.S. provisional application Ser. No. 63/299,114, filed on Jan. 13, 2022. All documents above are incorporated herein in their entirety by reference.

### FIELD OF THE INVENTION

The present invention relates to an apparatus and a method for producing Li metal. More specifically, the method and apparatus make use of select liquid-liquid separators. The present invention also relates to an apparatus and a method for producing Li metal from lithium oxide.

### BACKGROUND OF THE INVENTION

It has been known to produce lithium metal through the electrolysis of lithium-containing fused salts. Impurities of whatever kind are highly undesirable in lithium metal if it is to be used in nuclear technology, in the production of alloys and in lithium batteries.

In commercial practice, lithium metal is produced by electrolysis of a molten mixture of lithium chloride and potassium chloride according to the following global reaction:

LiCl→Li+Cl₂.

The fused salt mixture is electrolyzed to produce Li metal at the cathode and chlorine gas at the anode.

In conventional cells with diaphragm, a porous diaphragm or more frequently a metal sheet with a certain open area (around 30 to 50 percent) is inserted between the anode and cathode to assist in the separation of the electrolysis products. The liquid lithium metal droplets rise slowly to the surface of the molten mixture on the cathode side of the diaphragm, coalescing into larger droplets along the way. The liquid Li metal thus accumulates at the surface of the molten mixture, on the cathode side of the diaphragm, where it is skimmed. Chlorine gas is collected on the anode side of the diaphragm

However, the use of such diaphragm is associated with issues such as:
Short life due to corrosion (2 to 6 months),
Plugging with debris (increased cell voltage),
Loss of alignment (cell short circuits),
Gas blanketing of the anode (increased voltage and anode corrosion due to increased current density), and
Anode corrosion (increased cell voltage due to increased anode-cathode gap).

Electrolysis without the use of a diaphragm is also known. It allows decreasing cell voltage and the accompanying problems and eliminates the above issues linked to the diaphragm.

Electrolysis without diaphragm is achieved by virtue of the rapid natural circulation of the electrolytic medium, which results from the entrainment within the electrolytic medium of the chlorine bubbles generated at the anode. In this process, the flow of the electrolyte is due to the gas-lift pump action of the rising chlorine gas. The electrolytic medium is entrained vertically by the ascending movement of the chlorine bubbles in the interspace located between the anode and the cathode, after which it descends to the space located beyond the cathode to recirculate within the space between the anode and the cathode. The speed of circulation of said medium is high: if Vo is the velocity of movement of the electrolytic medium entering the cell in the absence of natural recirculation, the velocity V actually attained is approximately 250 times Vo, due to said recirculation. The interelectrode distance must be controlled, since if it is too large, the minimal rising velocity is not reached and if it is too small, undesirable contact between lithium metal droplets and chlorine gas is increased. In both cases, the back reaction between lithium metal and the chlorine gas results in a lower current efficiency.

Typically, in such processes, the molten mixture that has risen is collected adjacent to the surface level of the molten mixture and withdrawn from the electrolytic cell. It is then supplied to a decantation tank sealed from the chlorine gas atmosphere in the electrolytic cell. The electrolyte and lithium are separated under this protective gas atmosphere, lithium metal is discharged, and the electrolyte is returned to the electrolytic cell.

The use of lithium chloride in these processes remains problematic. Indeed, LiCl is very hygroscopic and difficult to dry, which increases expenses and can introduce impurities. More importantly, there can be residual water, which leads to the formation of oxygen-containing products and hydrogen, with the accompanying risks of explosions, and oxidation of the anode. It has been suggested to use Li₂CO₃ in addition to or in replacement of LiCl in the electrolytic cell. However, this is only possible in electrolytic cells using a diaphragm. Otherwise, Li₂CO₃ may react with the lithium produced at the cathode according to the following reaction:

Li₂CO₃+4 Li→3 Li₂O+C

to form elemental carbon and lithium oxide. In this case, the carbon may accumulate in the cell in form of a sludge.

### SUMMARY OF THE INVENTION

In accordance with the present invention, there is provided:

1. An apparatus for producing lithium metal by electrolysis, the apparatus comprising:
a liquid-liquid separator and
a diaphragmless electrolytic cell equipped with:
   an anode and a cathode immersed in an electrolysis medium comprising molten LiCl,
   a gaseous chlorine outlet located at the top of the cell, and
   a Li metal/electrolysis medium mixture outlet adjacent to a surface level of the electrolysis medium in the cell, wherein said mixture outlet is in fluid connection with the liquid-liquid separator to allow passage of a mixture of the electrolysis medium and lithium metal produced by the electrolytic cell into the liquid-liquid separator,
wherein said liquid-liquid separator comprises at least one film coalescer or at least one centrifugal separator for separating the lithium metal produced by the electrolytic cell from the electrolysis medium.

2. The apparatus of embodiment 1, wherein the liquid-liquid separator comprises at least one film coalescer, preferably the liquid-liquid separator comprises at least two or more film coalescers in series.

3. The apparatus of embodiment 1 or 2, wherein the liquid-liquid separator comprises at least one centrifugal separator, preferably the liquid-liquid separator comprises two or more centrifugal separators in series.

4. The apparatus of any one of embodiments 1 to 3, wherein the liquid-liquid separator comprises at least one film coalescer in series with at least one centrifugal separator.

5. The apparatus of any one of embodiments 1 to 4, wherein the film coalescer(s) is(are) a plate separator and/or a packed bed column, preferably the film coalescer(s) is(are) a plate separator.

6. The apparatus of any one of embodiments 1 to 5, wherein the centrifugal separator(s) is(are) a cyclone and/or a centrifuge, preferably the centrifugal separator(s) is(are) a cyclone.

7. The apparatus of any one of embodiments 1 to 6, wherein the electrolysis medium further comprises molten lithium oxide, molten lithium carbonate and/or a molten alkali halogenide (preferably a molten alkali chloride, more preferably molten KCl).

8. The apparatus of any one of embodiments 1 to 7, wherein the cell further comprises an electrolyte medium inlet towards the base of the cell.

9. The apparatus of any one of embodiments 1 to 8, further comprising an electrolysis medium reservoir and a first conduit fluidly connecting the base of the reservoir to the base of the cell.

10. The apparatus of embodiment 9, wherein the reservoir is equipped with a LiCl/LiCl precursor inlet located towards the top of the reservoir.

11. The apparatus of embodiment 9 or 10, further comprising a chlorine bubbler in the reservoir.

12. The apparatus of embodiment 11, further comprising a fourth conduit fluidly connects the gaseous chlorine outlet of the cell and to the chlorine bubbler in the reservoir.

13. The apparatus of any one of embodiments 9 to 12, wherein the reservoir is equipped with a gas outlet for the removal of by-product gases.

14. The apparatus of any one of embodiments 1 to 13, further comprising a collection tank for collecting a stream of liquid comprising Li metal produced by the liquid-liquid separator.

15. The apparatus of embodiment 14, wherein the collection tank is located under the liquid-liquid separator.

16. The apparatus of embodiment 14 or 15, further comprising a second conduit fluidly connecting the collection tank to the reservoir, preferably wherein the second conduit ends at a desired height for the level of electrolysis medium in the collection tank.

17. The apparatus of any one of embodiments 14 to 16, wherein the collection tank comprises a lithium metal outlet for discharging the produced lithium metal.

18. The apparatus of any one of embodiments 1 to 17, wherein the liquid-liquid separator (and the collection tank if present) are enclosed within a separation chamber, preferably immediately adjacent to electrolytic cell.

19. The apparatus of embodiment 18, wherein the liquid-liquid separator is located between, and immediately adjacent to, the electrolysis medium reservoir and the electrolytic cell.

20. The apparatus of any one of embodiments 1 to 19, further comprising:
a chlorination reactor for the chlorination of Li₂O into LiCl or a LiCl—Li₂O mixture, wherein the chlorination reactor is equipped with a chlorine gas inlet, an oxygen gas outlet, a Li₂O inlet, a LiCl/LiCl—Li₂O mixture outlet, and a heating element, and a fifth conduit connecting the LiCl/LiCl—Li₂O mixture outlet of the chlorination reactor either to the LiCl/LiCl precursor inlet of the reservoir or to the electrolyte medium inlet of the cell.

21. The apparatus of embodiment 20, further comprising a sixth conduit fluidly connecting the gaseous chlorine outlet of the cell and to the chlorine gas inlet of the chlorination reactor.

22. The apparatus of any one of embodiments 1 to 21, further comprising:
a dehydration reactor for the production of Li₂O from LiOH, wherein the dehydration reactor is equipped with a water vapor outlet, a LiOH inlet, a Li₂O outlet, and a heating element and/or a vacuum pump, and
a seventh conduit connecting the Li₂O outlet of the dehydration reactor to the Li₂O inlet of the chlorination reactor, to the LiCl/LiCl precursor inlet of the reservoir or to the electrolyte medium inlet of the cell.

23. The apparatus of any one of embodiments 1 to 22, further comprising:
a decarbonation reactor for the production of Li₂O from Li₂CO₃, wherein the decarbonation reactor is equipped with a CO₂ gas outlet, a Li₂CO₃ inlet, Li₂O outlet, and a heating element and/or a vacuum pump, and
an eighth conduit connecting the Li₂O outlet of the decarbonation reactor to the Li₂O inlet of the chlorination reactor, to the LiCl/LiCl precursor inlet of the reservoir or to the electrolyte medium inlet of the cell.

24. A method for producing lithium, the method comprising:
a) electrolyzing an electrolysis medium comprising molten LiCl in a diaphragmless electrolytic cell,
b) collecting a mixture of lithium metal and electrolysis medium from said cell, and
c) coalescing or separating lithium metal from said mixture using a liquid-liquid separator, wherein said liquid-liquid separator comprises at least one film coalescer or at least one centrifugal separator.

25. The method of embodiment 24, wherein the liquid-liquid separator comprises at least one film coalescer, preferably the liquid-liquid separator comprises at least two or more film coalescers in series.

26. The method of embodiment 24 or 25, wherein the liquid-liquid separator comprises at least one centrifugal separator, preferably the liquid-liquid separator comprises at least two or more centrifugal separators in series.

27. The method of any one of embodiments 24 to 26, wherein the liquid-liquid separator comprises at least one film coalescer in series with at least one centrifugal separator.

28. The method of any one of embodiments 24 to 27, wherein the film coalescer(s) is(are) a plate separator and/or a packed bed column, preferably film coalescer(s) is(are) a plate separator.

29. The method of any one of embodiments 24 to 28, wherein the centrifugal separator(s) is(are) a cyclone and/or a centrifuge, preferably the centrifugal separator(s) is(are) a cyclone.

30. The method of any one of embodiments 24 to 29, further comprising the step of feeding molten LiCl, a precursor thereof, or a mixture thereof to the cell, and, if a precursor is fed, allowing chlorine gas produced by the cell to chlorinate the precursor thus yielding molten LiCl.

31. The method of embodiment 30, further comprising the step of holding the molten LiCl, the precursor thereof, or the mixture thereof in an electrolysis medium reservoir before feeding the molten LiCl, the precursor thereof, or the mixture thereof to the cell.

32. The method of embodiment 30 or 31, wherein molten LiCl or a mixture of molten LiCl and a precursor thereof (preferably molten LiCl alone) is fed to the cell.

33. The method of embodiment 31 or 32, further comprising the step of adding LiCl, the precursor thereof, and/or the mixture thereof to a bath of molten LiCl in the electrolysis medium reservoir to replenish the electrolysis medium.

34. The method of any one of embodiments 31 to 33, further comprising the step of producing molten LiCl from a LiCl precursor in the reservoir.

35. The method of embodiment 34, wherein the precursor is added to molten LiCl in the reservoir, and wherein chlorine gas is preferably bubbled in the reservoir, more preferably using chlorine gas produced in the cell.

36. The method of any one embodiment 30 to 36, wherein the precursor is lithium oxide, lithium carbonate, and/or a lithium salt other than LiCl; preferably the precursor is lithium oxide or lithium carbonate, more preferably the precursor is lithium oxide.

37. The method of any one of embodiments 30 to 36, further comprising the step of producing LiCl or a LiCl—Li₂O mixture by chlorination of lithium oxide (preferably using chlorine gas, most preferably using chlorine gas produced in the cell) and then adding the LiCl or LiCl—Li₂O mixture to the reservoir or to the cell.

38. The method of any one of embodiments 30 to 37, further comprising the step of producing Li₂O by dehydration of lithium hydroxide or by decarbonation of lithium carbonate.

39. The method of any one of embodiments to 24 to 38, further comprising the step of collecting a stream of liquid produced by the liquid-liquid separator, said stream comprising Li metal and the electrolysis medium, and allowing decantation of the stream into a phase of Li metal over a phase of electrolysis medium.

40. The method of any one of embodiments 24 to 39, further comprising the step of reusing the electrolysis medium from the liquid-liquid separator.

41. The method of any one of embodiments 24 to 41, further comprising the step of using heat from the cell to heat the separator.

42. A method for producing lithium metal from Li₂O, the method comprising:
1) feeding i) Li₂O, ii) LiCl produced from Li₂O, or iii) a mixture thereof to an electrolytic cell, said electrolytic cell comprising an anode, a cathode and an electrolysis medium comprising molten LiCl; and
2) electrolyzing the molten LiCl in said electrolytic cell to produce Li metal and chlorine gas.

43. The method of embodiment 42, wherein Li₂O is fed to the cell at step 1) and wherein the chlorine gas produced at step 2) is allowed to react with the Li₂O to produce LiCl, which is then electrolyzed at step 2) to produce Li metal.

44. The method of embodiment 42, further comprising chlorinating Li₂O to produce LiCl, and then feeding the LiCl produced from Li₂O, with or without unreacted Li₂O, to the cell at step 1).

45. The method of embodiment 44, wherein said chlorinating is carried out in a chlorination reactor.

46. The method of embodiment 44 or 45, comprising bubbling chlorine in a molten LiCl bath containing Li₂O in a chlorination reactor and then feeding the resulting LiCl, with or without unreacted Li₂O, to the electrolytic cell.

47. The method of embodiment 46, wherein a gas bubbler is used for bubbling chlorine.

48. The method of embodiment 46 or 47, wherein chlorine gas produced at step 2) is used for said bubbling in the chlorination reactor.

49. The method of embodiment 44 or 45, comprising chlorinating solid Li₂O using chlorine gas and then feeding the resulting LiCl, with or without unreacted Li₂O, to the electrolytic cell.

50. The method of embodiment 49, wherein chlorine gas produced at step 2) is used for chlorinating the solid Li₂O.

### BRIEF DESCRIPTION OF THE DRAWINGS

In the appended drawings:

FIG. 1 is a cross-sectional view of an example of a single plate separator.

FIG. 2 is a cross-sectional view of an example of a multiple-plate separator.

FIG. 3 is a cross-sectional view of an example of a single plate separator with a place with a texture or supporting a bed.

FIG. 4 is a cross-sectional view of an example of a packed bed column.

FIG. 5 is a cross-sectional view of an example of a multi-stage column.

FIG. 6 is a partial sectional view of an example of a cyclone.

FIG. 7 is a cross-sectional view of an example of a tubular centrifuge.

FIG. 8 is a scheme showing the configuration of the electrolytic cell, the separation chamber and the reservoir in an embodiment of the apparatus of the invention.

FIG. 9 is a scheme showing the configuration of the electrolytic cell, the separation chamber and the reservoir in another embodiment of the apparatus of the invention.

FIG. 10 is a cross-sectional view of an apparatus according to an embodiment of the invention.

FIG. 11 is a cross-sectional view of an apparatus according to another embodiment of the invention.

FIG. 12 is a cross-sectional view of an apparatus according to yet another embodiment of the invention.

FIG. 13 shows the chlorination rates of Li₂O to LiCl in molten LiCl—KCl mixture at 400° C.

### DETAILED DESCRIPTION OF THE INVENTION

The present application is an apparatus and a method for producing lithium with an undivided (i.e., diaphragmless) electrolytic cell i.e., a cell using the gas lift effect. As noted above, in such cells, it is well known that decreasing the interelectrode distance to about an optimal distance, has the desired effect of quickly entraining the chlorine gas bubbles and the small Li droplets produced at both electrodes up towards the surface of the electrolysis medium (molten LiCl salt) used in the cell, while reducing the likelihood of them interacting together and undesirably forming lithium chloride.

This gas lift technique is not without problems, however. Indeed, in such process, it is essential to ensure that the mixture of metal and molten salt rising in the interelectrode space is withdrawn quickly. However, the short residence time of lithium metal droplets needed to achieve reasonable current efficiencies means that the droplets of Li metal produced at the cathode, which are very small, do not have enough time to efficiently coalesce. Also, the increased rising velocity of the chlorine gas bubbles produced at the anode creates a much higher turbulence in the space between the anode and the cathode which in turn slows down, or even prevents, coalescence of the Li droplets in the electrolytic cell. As such, the mixture of metal and molten salt removed from the cell contains very small Li metal droplets dispersed in the molten salt.

All of this makes separating the Li droplets from the molten salt phase difficult. In particular, because of the droplet size, it takes a long time for the Li metal to separate from the molten salt(s) in the decantation tanks taught by the prior art, even when using a device such as that taught in U.S. Pat. No. 4,740,279. Therefore, high-volume decantation reservoirs capable of containing all the liquid received from the electrolyte cell for as long as it takes to achieve separation are needed.

It should not be forgotten that the Li metal/salt separation is, of course, made more challenging by the high temperatures involved, i.e., hot enough for LiCl and lithium metal to be liquid, and it needs to achieve rapid separation when lithium is produced at a high rate.

Furthermore, this separation is made yet more challenging by the fact that the liquids to be separated are not a classical water/oil emulsion. However, most conventional separation techniques are geared toward such emulsions. In other words, they aim to separate a hydrophilic medium (water) from a hydrophobic (oil). However, liquid lithium metal and molten LiCl do not fit within that paradigm.

Herein, the liquid Li metal is more advantageously separated from the molten salt(s) by virtue of their difference in density. For example, at a temperature of 450° C., the molten salt LiCl is heavier with a density of around 1.64 g/cm³, while the liquid Li metal is lighter with a density of around 0.490 g/cm³. The present invention makes uses of devices using specific separation strategies based on this density difference to accelerate Li droplets coalescence, which in turn decreases significantly the time needed for an efficient separation of Li droplets from the molten salt. This results in a considerable increase in electrolytic cell productivity since the need for large decantation reservoirs as taught in the prior art is avoided.

More specifically, two types of liquid-liquid separators can be used in the apparatus and method of the invention:
film coalescers: high surface area devices that spread the liquids to be separated into a thin film (i.e., onto a large surface) and reduce their velocity, and
centrifugal separators: devices using centrifugal force to separate liquids.
   These devices have a compact geometry and high separation efficiency, both important characteristics needed for a successful separation, and eventual commercial scale implementation of diaphragmless electrolytic cells.

It should be noted that when exiting such a device, the liquid Li metal can be either completely separated from the molten salt or still in the form of droplets dispersed in the molten salt, but the droplets exiting such a device, are larger than when entering the separator. In such cases, the separation of the liquid Li metal (e.g., by decantation, for example in a collection tank catching the liquid exiting the device) is desirably accelerated.

Different types of film coalescers can be used. All are based on a same principle: spreading the flow of liquids to be separated onto a high surface area structure or assembly, which results in the formation of a thin film and a reduction in velocity of the flow of the Li droplets-molten salt mixture. Indeed, the combination of short rising path and the low velocity of the mixture facilitates the hydrodynamic coalescence of the Li droplets and therefore their separation from the molten salt electrolyte.

Examples of film coalescers include plate separators and packed bed columns.

In plate separators, at least one plate is used to spread the liquids to be separated into a film. The liquids indeed spread onto the plate(s) forming a film. In embodiments, a particle bed, a texture or a baffle is added to the plate surface to enhance separation. The plate can be flat, polished, curved, coated, or textured to provide properties which can increase the residence time, the surface contact, the adherence, or the separation.

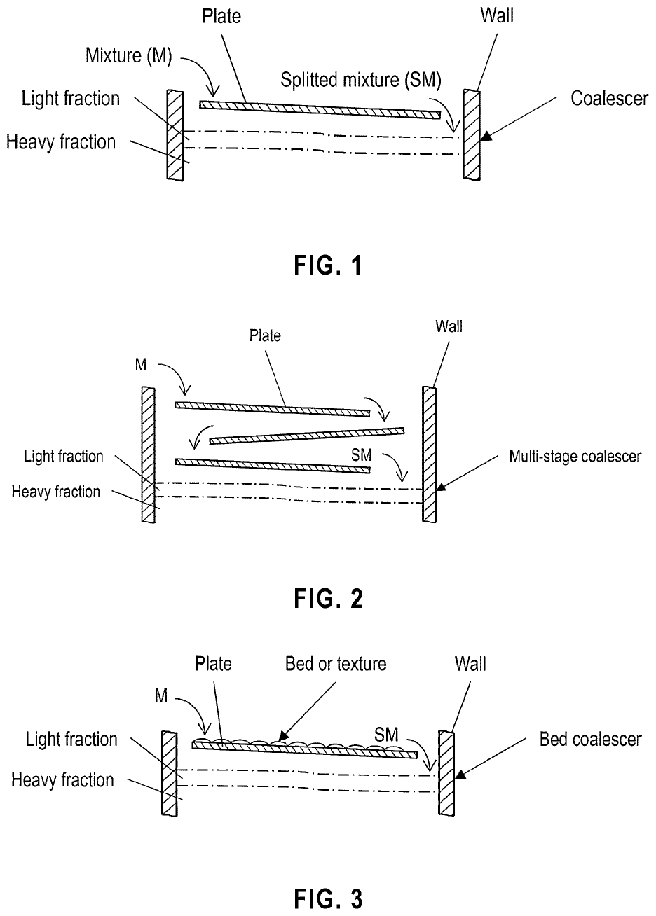

FIG. 1 shows a single plate separator (labelled plate) on which the mixture (M) to be separated spreads before falling into a collection tank as a split mixture (SM). FIG. 2 shows a multiple-plate separator in which the mixture (M) spreads successively on three plates before falling into a collection tank as a split mixture (SM). FIG. 3 shows a single plate separator supporting a particle bed on which the mixture (M) to be separated spreads before falling into a collection tank as a split mixture (SM).

In packed bed column, a bed of particles used to spread the liquids to be separated into a film. The liquids indeed spread around the particles forming a film. In embodiments, the particles can be made of metals, composites or ceramics and a coating may be added.

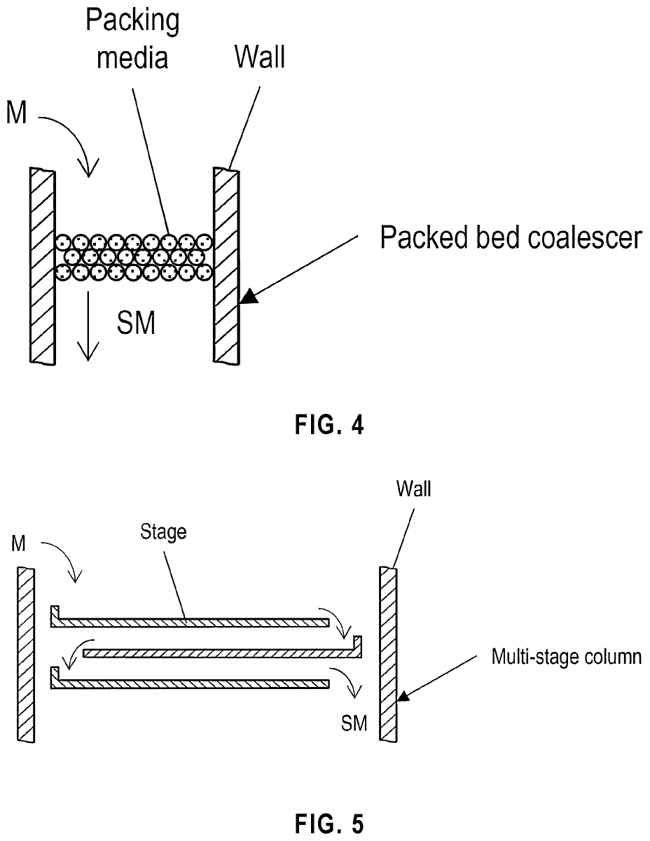

FIG. 4 shows a packed bed column in which the mixture (M) to be separated is introduced and from which a mixture with coalesced lithium droplets exits. FIG. 5 shows a multi-stage column comprising several plates in series and in which the mixture (M) to be separated is introduced and from which a mixture with coalesced lithium droplets exits.

In all cases, to increase the lifetime, the materials used have to offer a resistance to the corrosive environment involved in this separation. In embodiments, the plate(s), particle bed, texture and/or the baffle are made of metals, composites or ceramics. They can also be coated.

Different types of centrifugal separator can be used. All are based on a same principle: centrifugal force propels the Li droplets toward the surface of the molten salt where they will coalesce to form much larger Li drops that will separate much more quickly and easily from the molten salt.

Examples of centrifugal separators include cyclones (which have no moving part) and centrifuges (which do have moving parts).

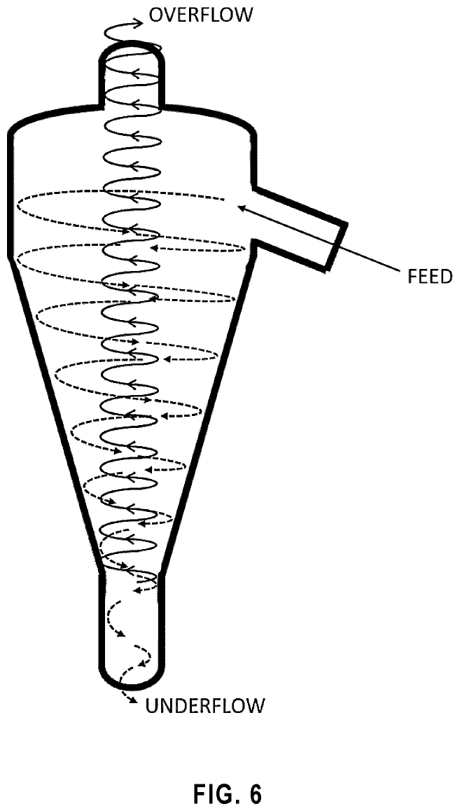

In a cyclone, the liquids to be separated are injected tangentially into a vessel with enough fluid pressure energy to create a rotational fluid motion. This rotational motion causes relative movement of products suspended in the fluid resulting in the separation of these products from each other or from the fluid. FIG. 6 shows an example of a cyclone in which a feed (mixture M) is injected tangentially. The light and heavy fractions contained in the feed are separated and the light fraction (overflow, Li metal) is pushed toward an overflow outlet located and the top of the vessel, while the heavy fraction (molten salts) exits by an under-flow outlet at the bottom of the vessel. Indeed, the mechanism of a cyclone is based on the principle of centrifugal force causing the separation of a heavy phase from a light phase by the differences in density. As the fluid is injected into the cyclone tangentially, it moves downward and near the wall but gradually and because of pressure loss, the light phase is driven to center and upward to exit from the overflow outlet; the heavy phase maintains its downward and near wall movement to exit from the under-flow outlet.

Cyclones can have various configurations as known in the art. For example:
the inlet can be simple, helical, single-entry, or multiple-entry, and
the main body can be cylinder-cylinder, cylinder-cone, cylinder-cone-cone, or vortex finder.
   All these configurations are contemplated for use in the present apparatus and method.

A centrifuge is a device that spins a liquid at high speed within a container, thereby separating liquids of different densities. So-called overflow centrifuge in which the separated heavy and light phase suspension are drained off and the liquid to be separated is constantly added are preferred. Common types of such centrifuges include separator centrifuges (such as solid bowl centrifuges and conical plate centrifuges), tubular centrifuges, and decanter centrifuges.

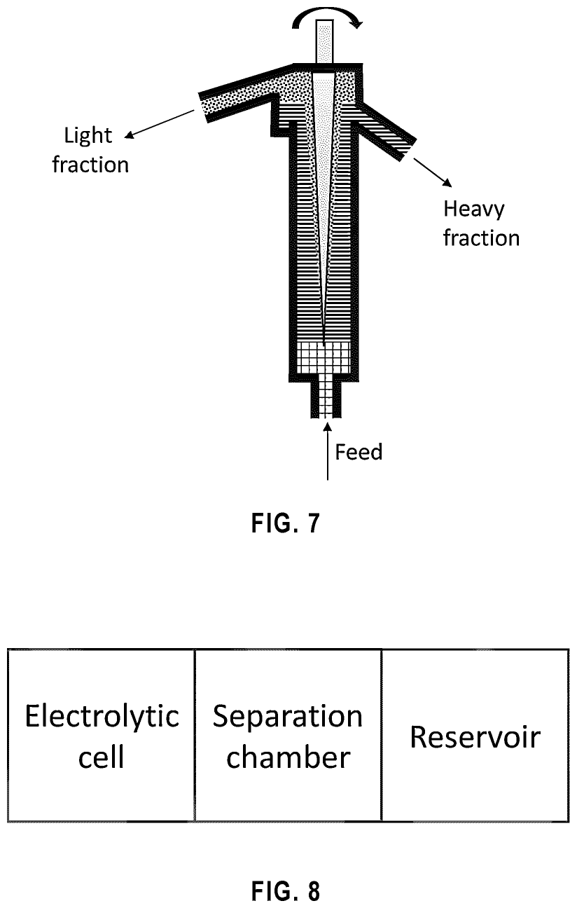

FIG. 7 show an example of a tubular centrifuge used for the continuous separation of liquids. In this case, the rotating bowl is made of a long hollow tube. For continuous separation, the fluid mixture to be centrifuged enters at one end of this tube near the central axis. The separated liquids are removed in two separation streams towards the other end of the tube. The heavy phase is removed peripherally, while the light phase is pushed forward and removed from the end of the tube.

In embodiments, two or more of the above devices (of a same type or of different types) are used in series to enhance coalescence of the lithium droplets. For example, two centrifuges can be used in series; or a packed bed column can be used after a plate separator.

### Apparatus Comprising a Liquid-Liquid Separator

In another aspect of the invention, there is provided an apparatus for producing lithium metal by electrolysis, the apparatus comprising:
a liquid-liquid separator and
a diaphragmless electrolytic cell equipped with:
   an anode and a cathode immersed in an electrolysis medium comprising molten LiCl,
   a gaseous chlorine outlet located at the top of the cell, and
   a Li metal/electrolysis medium mixture outlet adjacent to a surface level of the electrolysis medium in the cell, wherein said mixture outlet is in fluid connection with the liquid-liquid separator to allow passage of a mixture of the electrolysis medium and lithium metal produced by the electrolytic cell into the liquid-liquid separator,
      wherein said liquid-liquid separator comprises at least one film coalescer or at least one centrifugal separator for separating the lithium metal produced by the electrolytic cell from the electrolysis medium.

The mixture outlet lets the Li metal/electrolysis medium mixture produced by electrolysis out of the cell.

This mixture outlet may, for example, comprise a hole in a wall separating the cell from the liquid-liquid separator, a chute, or a siphon.

As described above, the separator accelerates the coalescence of the liquid Li metal droplets and their decantation out of the electrolysis medium (compared to simply discharging the mixture in a decantation tank). This advantageously obviates the need for a decantation tank with a capacity large enough to contain all the electrolysis medium and liquid Li metal produced in all the time it takes for such a “natural” decantation to occur.

In embodiments, the liquid-liquid separator comprises two or more film coalescers in series.

In embodiments, the liquid-liquid separator comprises two or more centrifugal separators in series.

In embodiments, the liquid-liquid separator comprises at least one film coalescer in series with at least one centrifugal separator.

The liquid-liquid separator, the film coalescer, and the centrifugal separator are as described in the previous section.

Typically, the anode is cylindrical, the cathode is tubular, and the anode is surrounded by the cathode. As mentioned above, it is well known to adjust the interelectrode distance (i.e., the distance between the anode and the cathode) to about an optimal distance, which has the desired effect of quickly entraining the chlorine gas bubbles and the small Li droplets produced at both electrodes up towards the surface of the electrolysis medium (molten LiCl salt) used in the cell, while reducing the likelihood of them interacting together and undesirably forming lithium chloride.

Typically, the anode is made of graphite. Other materials such as carbon, semi-graphitic carbon, vitreous carbon, cermet or inert alloys can also be used.

Typically, the cathode is made of mild steel. The potential use of Ti or Ni have also been proposed.

As noted above, the electrolysis medium comprises molten LiCl. In embodiments, the electrolysis medium further comprises molten lithium oxide, molten lithium carbonate and/or a molten alkali halogenide (preferably an alkali chloride, such as KCl). However, in preferred embodiments, the electrolysis medium is free of lithium carbonate, preferably free of lithium carbonate and lithium oxide. Most preferably, the electrolysis medium is molten LiCl alone or combined with an alkali halogenide, preferably KCl (which decreases the mixture's melting point). In embodiments, the electrolysis medium consists of molten LiCl, or a mixture of LiCl and KCl, and unavoidable impurities only. In embodiments, the electrolysis medium consists of molten LiCl and unavoidable impurities only.

In embodiments, LiCl, a precursor thereof, or a mixture thereof is fed to the cell so as to replenish the electrolysis medium. In preferred such embodiments, LiCl or a mixture of LiCl and a precursor, more preferably LiCl (or alternatively, a LiCl precursor) are fed to the cell. In such cases, the cell further comprises an electrolyte medium inlet towards the bottom of the cell. In embodiments, the precursor is lithium oxide, lithium carbonate, and/or a lithium salt other than LiCl; preferably lithium oxide or lithium carbonate, more preferably lithium oxide.

In embodiments in which Li₂O is used as a LiCl precursor (alone or in a mixture with LiCl), it can be produced either:
by dehydration of lithium hydroxide (2 LiOH→Li₂O+H₂O), e.g., in a dehydration reactor or
by decarbonation of lithium carbonate (Li₂CO₃→Li₂O+CO₂), e.g., in a decarbonation reactor.
   Such reactors will be discussed further below.

In embodiments, LiCl or a LiCl—Li₂O mixture is produced by chlorination of lithium oxide in a chlorination reactor and then added to the cell. The reaction at play is:

$$2 {Li}_{2} O + 2 {Cl}_{2} \to 4 LiCl + {O}_{2}$$

When this reaction is incomplete, some unreacted Li₂O remains and a LiCl—Li₂O mixture is obtained. This is not deleterious as Li₂O, contrary to Li₂CO₃, does not deleteriously react with Li metal.

In preferred embodiments, the apparatus further comprises an electrolysis medium reservoir and a first conduit fluidly connecting the base of the reservoir to the base of the cell. The first conduit connecting the reservoir to the cell carries the electrolysis medium from the reservoir towards the cell. The reservoir can simply hold the electrolysis medium or can also act as a reactor in which LiCl is produced. Such embodiments will be discussed further below.

In preferred embodiments, the apparatus further comprises a collection tank for collecting a stream of liquid comprising Li metal produced by the liquid-liquid separator. In embodiments, the collection tank comprises a lithium metal outlet for discharging the produced lithium metal.

In embodiments, the collection tank is located under the liquid-liquid separator. In such embodiments, the stream of liquid comprising Li metal can simply fall from the liquid-liquid separator into the collection tank.

When the stream collected in the collection tank also comprises the electrolysis medium, the collection tank can further act as a decantation tank allowing final separation of Li metal from the electrolysis medium. In embodiments, the apparatus further comprises a second conduit fluidly connecting the collection tank (where the electrolysis medium accumulates) to the reservoir. In that way, the electrolysis medium can be reused in the electrolytic cell. In embodiments, the second conduit ends at a desired height for the level of electrolysis medium in the collection tank. This is a simple and effective means to control the level of electrolysis medium in the collection tank. In some alternative embodiments, e.g., those in which the apparatus does not comprise an electrolysis medium reservoir, a third conduit fluidly connects the base of the collection tank to the electrolyte medium inlet of the cell.

In more preferred embodiments, the liquid-liquid separator (and the collection tank if present) are enclosed within a separation chamber. Preferably, the separation chamber is located immediately adjacent to electrolytic cell.

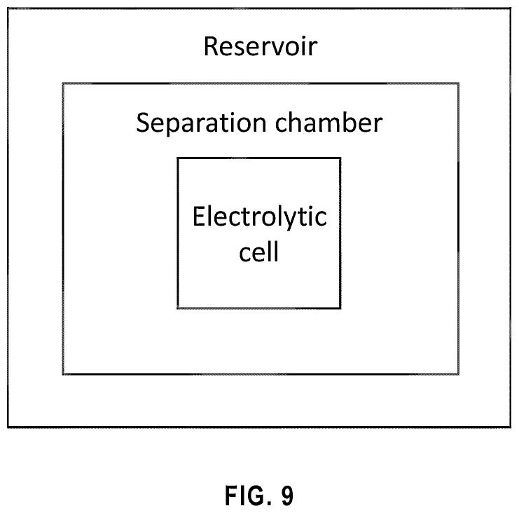

In embodiments, the separation chamber is located between, and immediately adjacent to, the electrolysis medium reservoir and the electrolytic cell. An advantage of such embodiments is that the heat emanating from the electrolytic cell is used for maintaining the required temperature in both the separation chamber and the electrolysis medium reservoir. To achieved this, the cell, separation chamber, and reservoir can be side-by-side as shown in FIG. 8 or peripherally enclosed within each other, preferably with the cell on the inside as shown in FIG. 9.

As needed, additional heating elements can be provided to heat the separation chamber and/or to the electrolysis medium reservoir.

In embodiment, the reservoir is equipped with a LiCl—LiCl precursor inlet located towards the top of the reservoir. This inlet allows adding LiCl, a precursor thereof, or a mixture thereof (preferably LiCl or a mixture of LiCl and a precursor, more preferably LiCl, or alternatively a LiCl precursor) to a bath of LiCl in the reservoir so as to replenish the electrolysis medium. The LiCl/precursor/mixture can be in powder form (i.e., cold) or in liquid form, preferably in powder form. In embodiments where a precursor is used, LiCl is produced from the precursor in the cell.

In embodiments, the precursor is lithium oxide, lithium carbonate, and/or a lithium salt other than LiCl; preferably lithium oxide or lithium carbonate, more preferably lithium oxide.

In preferred embodiments, chlorine gas is bubbled in the bath of LiCl in the reservoir. In such embodiments, LiCl is produced from the precursor in the reservoir. Hence, in such embodiments, the apparatus further comprises a chlorine bubbler in the reservoir. The reservoir is also equipped with a gas outlet that allows removal of by-product gases such as O₂ and/or CO₂ produced by the chemical reactions at play, which can be for example:

$$2 {Li}_{2} {CO}_{3} + 2 {Cl}_{2} \to 4 LiCl + 2 {CO}_{2} {O}_{2} \\ 2 {Li}_{2} O + 2 {Cl}_{2} \to 4 LiCl + {O}_{2}$$

Preferably, the chlorine gas produced by the electrolytic cell is used to produce the LiCl in the reservoir. In preferred such embodiments, a fourth conduit fluidly connects the gaseous chlorine outlet of the cell and to the chlorine bubbler in the reservoir.

In embodiments, when Li₂O is used as a LiCl precursor (alone or in a mixture with LiCl) to be added to the reservoir, it can be produced (as noted above) either:
by dehydration of lithium hydroxide (2 LiOH→Li₂O+H₂O), e.g., in a dehydration reactor or
by decarbonation of lithium carbonate (Li₂CO₃→Li₂O+CO₂), e.g., in a decarbonation reactor.
   Such reactors will be discussed further below. In more preferred embodiments, LiCl or a LiCl—Li₂O mixture is produced by chlorination of lithium oxide in a chlorination reactor and then added to the reservoir.

Therefore, in embodiments, the apparatus further comprises:
a chlorination reactor for the chlorination of Li₂O into LiCl or a LiCl—Li₂O mixture, wherein the chlorination reactor is equipped with a chlorine gas inlet, an oxygen gas outlet, a Li₂O inlet, and a LiCl/LiCl—Li₂O mixture outlet, and optionally with a heating element, and
a fifth conduit connecting the LiCl/LiCl—Li₂O mixture outlet of the chlorination reactor either to the LiCl/LiCl precursor inlet of the reservoir or to the electrolyte medium inlet of the cell.
   This fifth conduit allows discharging the LiCl or LiCl—Li₂O mixture from the chlorination reactor into the reservoir or into the cell. The LiCl or LiCl—Li₂O mixture discharged by the fifth conduit can be solid or liquid, preferably solid.

In embodiments, the temperature inside the chlorination reactor is controlled as known in the art.

Preferably, the chlorine gas produced by the electrolytic cell is used to produce the LiCl/LiCl—Li₂O mixture in the chlorination reactor. In preferred such embodiments, a sixth conduit fluidly connects to the gaseous chlorine outlet of the cell and to the chlorine gas inlet of the chlorination reactor.

In yet more preferred embodiments, the Li₂O reactant for the chlorination reactor is produced either:
by dehydration of lithium hydroxide (2 LiOH→Li₂O+H₂O), e.g., in a dehydration reactor or
by decarbonation of lithium carbonate (Li₂CO₃→Li₂O+CO₂), e.g., in a decarbonation reactor.
   and then added to the chlorination reactor.

Therefore, in embodiments, the apparatus further comprises:
a dehydration reactor for the production of Li₂O from LiOH, wherein the dehydration reactor is equipped with a water vapor outlet, a LiOH inlet, a Li₂O outlet, and a heating element and/a vacuum pump, and
a seventh conduit connecting the Li₂O outlet of the dehydration reactor to the Li₂O inlet of the chlorination reactor, to the LiCl/LiCl precursor inlet of the reservoir or to the electrolyte medium inlet of the cell.
   This seventh conduit allows discharging the Li₂O from the dehydration reactor into the chlorination reactor, the reservoir, or the cell. The Li₂O is typically in solid form.

In embodiments, the apparatus further comprises:
a decarbonation reactor for the production of Li₂O from Li₂CO₃, wherein the decarbonation reactor is equipped with a CO₂ gas outlet, a Li₂CO₃ inlet, a Li₂O outlet, and a heating element and/or a vacuum pump and
an eighth conduit connecting the Li₂O outlet of the decarbonation reactor to the Li₂O inlet of the chlorination reactor, to the LiCl/LiCl precursor inlet of the reservoir or to the electrolyte medium inlet of the cell.
   This eighth conduit allows discharging Li₂O from the decarbonation reactor into the chlorination reactor, the reservoir or the cell. The Li₂O is typically in solid form.

An advantage of these embodiments is that the CO₂ produced is of sufficient purity (it is not mixed with O₂ and have traces of Cl₂) to be used in many applications.

Also, the embodiments involving Li₂CO₃ have the advantage of decreasing costs as Li₂CO₃ is a form of lithium readily extracted by current mining processes.

In embodiments, the temperature/pressure inside the dehydration and decarbonation reactors can be controlled in the manner known in the art.

All the above embodiments involving the chlorination reactor or chlorination in the reservoir have the advantage of producing lithium metal of greater purity as it avoids introducing Li₂CO₃ in the electrolytic cell (as taught in the prior art). Indeed, in preferred embodiments, the electrolysis medium is free of lithium carbonate, preferably free of lithium oxide and lithium carbonate.

If an alkali halogenide is used in the electrolysis medium, it can be added to the reservoir by the inlet towards the top of the reservoir or by another inlet provided in the reservoir.

The electrolyte cell is a cell of the kind of diaphragmless cell known in the art, e.g., as described hereinbefore. It can be operated according to the parameters known in the art. The electrolyte cell can be, for example, as described in U.S. Pat. Nos. 4,724,055 and 4,740,279. In embodiments, in that electrolytic cell, a steel cathode is welded to the bottom of a closed cylindrical steel vessel, a vertical graphite anode is sealed from the atmosphere and has a portion which is surrounded by the cathode and immersed into the molten LiCl.

The anode is preferably made of graphite and is cylindrical in shape (for example, a bar); it may be sheathed (by a material such as alumina, quartz, silica, etc.) on the portion itself not immersed in the electrolysis medium and to a certain depth below the interface of the electrolysis medium and the gaseous phase.

The cathode is preferably cylindrical in shape; it may be attached to the wall of the cell by any means which do not obstruct the circulation of the electrolysis medium, and which provide electrical conduction.

The same potential is applied to the cathode and to the cell vessel. The negative terminal of the voltage source is connected to the bottom of the cell vessel.

As needed the flow in any one of the first to the eighth conduits can be aided by pumps as known to the person skilled in the art.

### Method Using a Liquid-Liquid Separator

There is also provided a method for producing lithium, the method comprising:
a) electrolyzing an electrolysis medium comprising molten LiCl in a diaphragmless electrolytic cell,
b) collecting a mixture of lithium metal and electrolysis medium from said cell, and
c) coalescing or separating lithium metal from said mixture using a liquid-liquid separator, wherein said liquid-liquid separator comprises at least one film coalescer or at least one centrifugal separator.

The liquid-liquid separator, film coalescer, centrifugal separator, electrolysis medium, and electrolytic cell (including the anode and cathode) are as described in the previous sections.

In embodiments, the method further comprises the step of feeding LiCl, a precursor thereof, or a mixture thereof (preferably LiCl or a mixture of LiCl and a precursor, more preferably LiCl, or alternatively, more preferably a LiCl precursor) to the cell. In preferred embodiments, the LiCl, a precursor thereof, or a mixture thereof is fed to the cell is held in an electrolysis medium reservoir before being fed to the cell. In embodiments, the precursor is lithium oxide, lithium carbonate, and/or a lithium salt other than LiCl; preferably lithium oxide or lithium carbonate, more preferably lithium oxide.

In embodiments, the method further comprises the step of collecting a stream of liquid produced by the liquid-liquid separator in a collection tank, said stream comprising Li metal and the electrolysis medium, and allowing decantation of the stream into a phase of Li metal over a phase of electrolysis medium. In embodiments, the stream is allowed to fall in the collection tank.

In embodiments, the method further comprises the step of reusing the electrolysis medium from liquid-liquid separator or from the collection tank in the cell or in the electrolysis medium reservoir. Preferably, the electrolysis medium from the collection tank is reused in the electrolysis medium reservoir.

In embodiments, the method further comprises the step of using heat from the cell to heat the separator (and the collection tank if present) and/or the reservoir. In preferred embodiments, the liquid-liquid separator (and the collection tank if present) are enclosed within a separation chamber. Preferably, the separation chamber is located immediately adjacent to electrolytic cell. In embodiments, the separation chamber is located between, and immediately adjacent to, the electrolysis medium reservoir and the electrolytic cell. The cell, separation chamber, and reservoir can be side-by-side as shown in FIG. 8 or peripherally enclosed within each other, preferably with the cell on the inside as shown in FIG. 9. As needed, additional heating elements can be provided to heat the separation chamber and/or the electrolysis medium reservoir.

In embodiments, the method further comprises the step of adding LiCl, a precursor thereof, or a mixture thereof (preferably LiCl or a mixture of LiCl and a precursor, more preferably LiCl, or alternatively, more preferably a LiCl precursor) to a bath of LiCl in the reservoir so as to replenish the electrolysis medium. In embodiments, the precursor is lithium oxide, lithium carbonate, and/or a lithium salt other than LiCl; preferably lithium oxide or lithium carbonate, more preferably lithium oxide.

In embodiments, LiCl is added to the reservoir in powder form (cold) or in liquid form, preferably it is in powder form.

In embodiments, the precursor added to the reservoir or to the cell is lithium oxide alone or in a mixture with LiCl.

In preferred embodiment, the method further comprises the step of producing LiCl from the precursor in the reservoir. In embodiments, the method further comprises bubbling chlorine in the reservoir. Preferably, a gas bubbler is used for bubbling chlorine. Preferably, the method comprises the step of using chlorine gas produced in the cell for bubbling in the reservoir.

In embodiments, the method further comprises the step of producing LiCl or a LiCl—Li₂O mixture by chlorination of lithium oxide and then adding the LiCl or LiCl—Li₂O mixture to the reservoir or to the cell. Preferably, the method comprises the step of using chlorine gas produced in the cell for chlorinating the lithium oxide. In embodiments, the temperature for the chlorination is controlled as known in the art. When the reaction is incomplete, some unreacted Li₂O remains and a LiCl—Li₂O mixture is obtained. This is not deleterious as Li₂O, contrary to Li₂CO₃, does not react with Li metal.

In more preferred embodiments, the method further comprises the step of producing Li₂O by dehydration of lithium hydroxide or by decarbonation of lithium carbonate.

An advantage of the embodiments involving decarbonation of lithium carbonate into lithium oxide is that the CO₂ produced is of sufficient purity (it is not mixed with O₂ and have traces of Cl₂) to be used in many applications. In embodiments, the temperature/pressure for dehydration and decarbonation can be in the manner known in the art.

The above processes involving lithium carbonate have the advantage of decreasing cost as Li₂CO₃ is a form of lithium readily extracted by current mining processes.

All the above embodiments involving the chlorination of a precursor (in the reservoir or before it is added to the reservoir) have the advantage of producing lithium metal of greater purity as it avoids introducing Li₂CO₃ in the electrolytic cell (as taught in the prior art). Indeed, in preferred embodiments, the electrolysis medium is free lithium carbonate, preferably free of lithium oxide and lithium carbonate.

In some of the above embodiments, some lithium oxide and/or lithium carbonate may remain in the LiCl. In preferred embodiments, the electrolysis medium is free of lithium carbonate, preferably free of lithium oxide and lithium carbonate.

If an alkali halogenide is used in the electrolysis medium, the method further comprises the step of adding the alkali halogenide to the reaction mixture.

Method for Producing Lithium Metal from Li₂O

In another aspect of the invention, there is provided a method for producing lithium metal from Li₂O, the method comprising:
1. feeding i) Li₂O, ii) LiCl produced from Li₂O, or iii) a mixture thereof to an electrolytic cell, said electrolytic cell comprising an anode, a cathode and an electrolysis medium comprising molten LiCl; and
2. electrolyzing the molten LiCl in said electrolytic cell to produce Li metal and chlorine gas.

This aspect of the invention is based on the following chemical reaction, which is the chlorination of lithium oxide: 2 Li₂O→2 Cl₂→4 LiCl+O₂.

In embodiments in which Li₂O is fed to the cell at step 1), the method comprises using the chlorine gas produced at step 2) to produce LiCl directly in the cell. This LiCl is then electrolyzed at step 2) to produce Li metal.

In embodiments, the method comprises first chlorinating Li₂O to produce LiCl, and then feeding LiCl to the cell at step 1). When this reaction is incomplete, some unreacted Li₂O remains and a LiCl—Li₂O mixture is obtained and fed to the reactor. This is not deleterious as Li₂O, contrary to Li₂CO₃, does not deleteriously react with Li metal.

In embodiments, said chlorinating can be carried out in a chlorination reactor.

In preferred embodiment, the method comprises bubbling chlorine in a molten LiCl bath containing Li₂O and then feeding the resulting LiCl (with or without residual Li₂O) to the electrolytic cell. Preferably, a gas bubbler is used for bubbling chlorine. Preferably, the method uses the chlorine gas produced by the cell for said bubbling.

In alternative preferred embodiment, the method comprises chlorinating solid Li₂O using chlorine gas and then feeding the resulting LiCl (with or without residual Li₂O) to the electrolytic cell. Preferably, the method uses the chlorine gas produced by the cell for chlorinating the solid Li₂O.

The electrolytic cell can be a diaphragmless electrolytic cell as described in the previous sections or an electrolytic cell comprising a diaphragm as taught in the prior art.

Note that the use of Li₂O is advantageous, since Li₂O, contrary to Li₂CO₃, does not undesirably react with Li metal. Also, it is less hygroscopic than LiCl and thus easier to use. In short, the disadvantages of the use LiCl or Li₂CO₃ as noted above are avoided.

In more preferred embodiments, the method further comprises the step of producing Li₂O by dehydration of lithium hydroxide or by decarbonation of lithium carbonate.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1

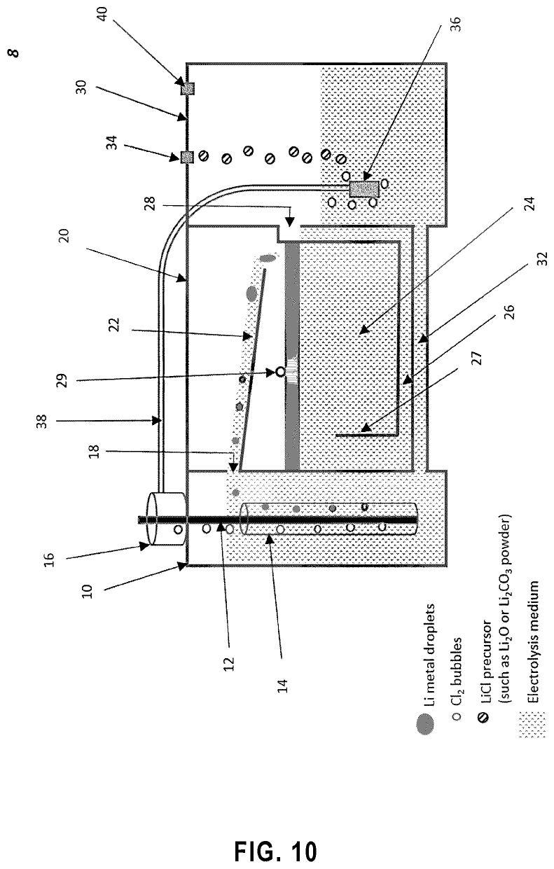

FIG. 10 is a cross-sectional view of an apparatus (8) according to an embodiment of the invention.

It shows a separation chamber (20) between an undivided (diaphragmless) electrolytic cell (10) and an electrolysis medium reservoir (30). The cell (10) comprises an anode (12), a cathode (14), a Cl₂ gas outlet (16), and a Li metal/electrolysis medium mixture outlet (18). The separation chamber (20) comprises a single plate film coalescer (22) connected to the medium mixture outlet (18) and located over a collection tank (24). The reservoir (30) is connected to the cell (10) by “first conduit” (32) located below the separation chamber (20). The reservoir (30) is also connected to the separation chamber (20) through second conduit (26). The flow in second conduit (26) is quiet thanks to vertical baffle (27). Second conduit (26) ends with overflow outlet (28), whose height can be adjusted in order to control the liquid level in collection tank (24). The reservoir (30) is equipped with a LiCl/LiCl precursor inlet (34) (allowing to introduce LiCl and/or a precursor of LiCl such as Li₂O or Li₂CO₃), a gas outlet (40) and a chlorine bubbler (36) connected to the Cl₂ gas outlet (16) by “fourth conduit” (38). The separation chamber is equipped with a lithium metal outlet (29) for collecting the Li metal produced.

In use, the cathode (14) is completely immersed in the electrolysis medium comprising LiCl. Chlorine gas bubbles evolve at the anode (12), while Li metal droplets are produced at the cathode (14). The chlorine gas is captured at the top of the cell (10) and bubbled in the reservoir (30). The reservoir (30) holds the electrolysis medium (including liquid LiCl) to which a LiCl precursor, here lithium oxide or lithium carbonate, is added via LiCl/LiCl precursor inlet (34). This produces LiCl that is sent to the cell by “first conduit” (32). A mixture of Li metal and LiCl is collected from the surface of the electrolysis medium in the cell (10) via the Li metal/electrolysis medium mixture outlet (18). The Li metal in this mixture is coalesced with a single plate film coalescer (22). The electrolysis medium with the coalesced Li metal droplets falls into a decantation tank where they separate into two phases and the electrolysis medium, free of Li droplets, is recycled to the reservoir (30) through second conduit (26). The Li metal collected in the decantation tank can be recovered through lithium metal outlet (29).

### Example 2

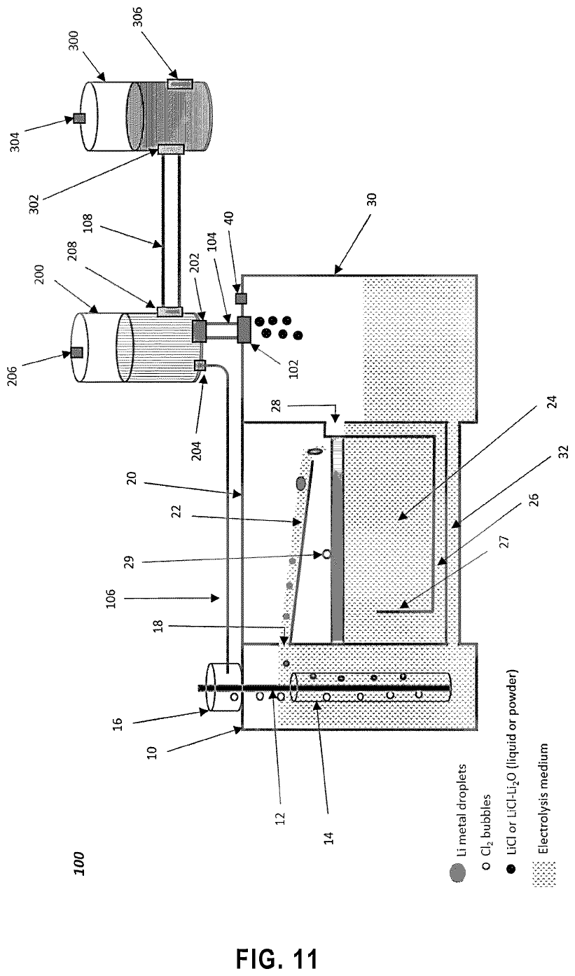

FIG. 11 shows an apparatus (100) similar to apparatus (10) shown in FIG. 10 except that the reservoir (30) is equipped with LiCl/LiCl precursor inlet (102) and the apparatus further comprises a chlorination reactor (200) for the production of LiCl or a LiCl—Li₂O mixture from Li₂O and a decarbonation reactor (300) (that is heated and/or under vacuum) for the production of Li₂O from Li₂CO₃.

The chlorination reactor (200) has a LiCl/LiCl—Li₂O mixture outlet (202) connected by “fifth conduit” (104) to the LiCl/LiCl precursor inlet (102) of the reservoir (30). The chlorination reactor (200) is equipped with a chlorine gas inlet (204) that is connected to the Cl₂ gas outlet (16) of the cell (10) by “sixth conduit” (106). The chlorination reactor (200) is further equipped with oxygen gas outlet (206) and a Li₂O inlet (208)

The decarbonation reactor (300) is equipped with a Li₂O outlet (302) connected to the Li₂O inlet (208) of the chlorination reactor (200) by “seventh conduit” (108) for carrying Li₂O from decarbonation reactor (300) to chlorination reactor (200). The decarbonation reactor (300) is further equipped with a CO₂ gas outlet (304) and a Li₂CO₃ inlet (306).

In use, a LiCl or a LiCl—Li₂O mixture is added to the reservoir (30). This LiCl or a LiCl—Li₂O is produced from Li₂O in the chlorination reactor (200). The chlorine gas captured at the top of the electrolytic cell (10) is sent to the chlorination reactor (200) while produced oxygen is withdrawn from the chlorination reactor (200) via oxygen outlet (206). This Li₂O is produced by decarbonation of Li₂CO₃ in the decarbonation reactor (300). The CO₂ produced is withdrawn from the decarbonation reactor (300) via CO₂ gas outlet (304).

### Example 3

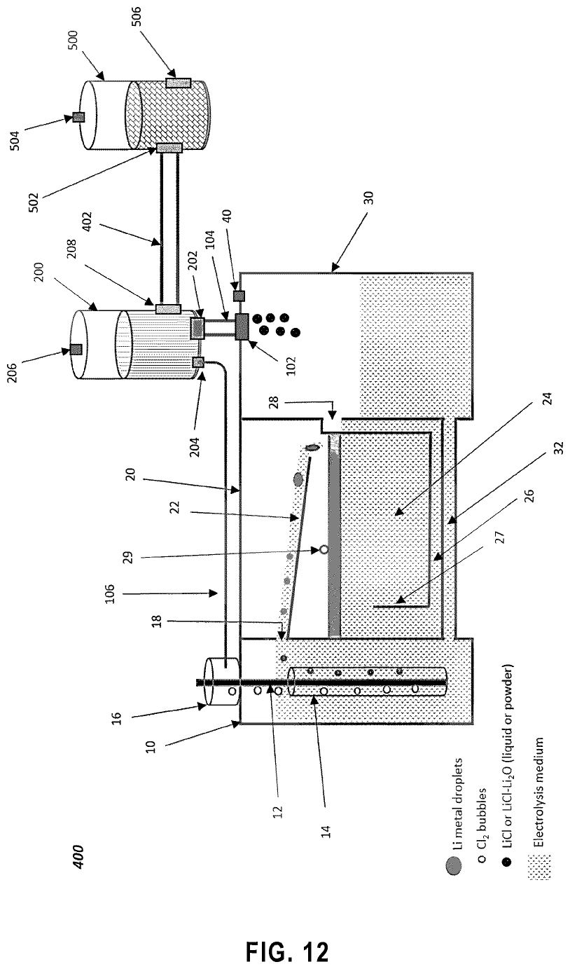

FIG. 12 shows an apparatus (400) similar to apparatus (100) shown in FIG. 11 except that the Li₂O for the chlorination reactor is produced by dehydration of LiOH in a dehydration reactor (500) (that is heated and/or under vacuum) rather than in decarbonation reactor (300).

The dehydration reactor (500) is equipped with a Li₂O outlet (502) connected to the Li₂O inlet (208) of the chlorination reactor (200) by “eighth conduit” (402). The dehydration reactor (500) is further equipped with a water vapor outlet (504) and a LiOH inlet (506).

In use, the Li₂O for the chlorination reactor (200) is produced by dehydration of Li₂CO₃ in the dehydration reactor (500). The water vapor produced is withdrawn from the dehydration reactor via water vapor outlet (504).

### Example 4

In order to demonstrate the efficacy of the single plate film coalescer (22)—see FIG. 10 and Example 1, in terms of separation of liquid Li droplets from the liquid electrolyte, the apparatus of FIG. 10 was manufactured in polycarbonate. The apparatus had the three compartments represented in FIG. 10: the electrolytic cell (10), the separation chamber (20) and the electrolysis medium reservoir (30). The electrolytic cell (10) consisted of a cylinder (0=130 mm, h=770 mm) with a medium mixture outlet (18) towards the separation chamber set at a height of 630 mm (total volume of 8,36 liters of liquid). The separation chamber (20) consisted of a 500 mm high cubical chamber having a width and a length of 310 and 430 mm respectively. Overflow outlet (28) towards the electrolyte reservoir was set to a height of 310 mm (total volume of 41,32 liters of liquid). The electrolysis medium reservoir (30) consisted of a 790 mm high cubical chamber having a width and a length of 270 and 430 mm, respectively. A magnetic pump was installed in first conduit (32) to recirculate the liquid from the bottom of the reservoir (30) to the bottom of the electrolytic cell (10). Excess liquid in electrolytic cell (10) overflowed into the separation chamber (20) through medium mixture outlet (18). The liquid then went through quiet second conduit 26 created by a vertical baffle (27) before overflowing in reservoir (30) through overflow outlet (28).

For the experiment, a 47% K₂CO₃ aqueous solution (with a density of 1.49 g/cm³ at room temperature) was used to simulate the LiCl—KCl (53%-47%) eutectic mixture that has a density of 1,64 at 450° C. in a conventional Li production electrolytic cell. Mineral oil (with a density of 0,857 g/cm³ at room temperature) was used to simulate liquid Li in the cell. To confer a yellow to orange color, a small amount of β-carotene was added to the mineral oil. This addition facilitates the visual observation of the oil behavior that was simulating the Li droplets.

A peristaltic pump was used to add at a controlled rate in the line the mineral oil where the liquid was pumped from the bottom of the reservoir (30) to the bottom of the electrolytic cell (10). In order to simulate the creation of small droplets of molten Li that are mixed with the LiCl—KCl electrolyte between the cathode and anode space (electrolytic cell without diaphragm operating in a gas-lift mode), an inline mixer was installed in the pipe (first conduit 32) right before the inlet at the bottom of electrolytic cell (10) to create very small mineral oil droplets in the K₂CO₃ solution. Two types of experiments were carried out.

In the first experiment, a single plate coalescer (22) 300 mm wide and 330 mm long was installed almost horizontally (with a slight downward angle to create a liquid height of 0.35 mm on the plate) at outlet (18) between the electrolytic cell (10) and the separation chamber (20). The K₂CO₃ solution was recirculated at a constant flow rate of 2 liters/min from the bottom of the reservoir (30) to the bottom of electrolytic cell (10) through first conduit (32). 1,5 liters of mineral oil was added to the separation chamber to create a 15 mm layer floating on top of the K₂CO₃ solution to simulate the accumulated molten Li produced in the electrolytic cell. Then, mineral oil was added at a constant rate of 1,3 g/min to the K₂CO₃ solution in the recirculation line (32). Mineral oil fine droplets created in the inline mixer rose in the electrolytic cell (10) simulating the rising of fine Li droplets created on the cathode and pushed upwards by the chlorine bubbles generated at the anode. The mixture of mineral oil droplets and the K₂CO₃ solution was constantly overflown from outlet (18) on the single coalescer plate (22). The angle of the coalescer plate (22) was adjusted to create a thin film of liquid of around 0.35 mm high which resulted in a residence time close to 1 second on the coalescer plate (22). The experiment was carried out for 6 hours during which 467 g of mineral oil was added at the bottom of the electrolytic cell (10). At the same time mineral oil was collected at lithium metal outlet (29) simulating the collection of the separated Li in an electrolytic cell that is operated at around 200 A with 85% current efficiency. After the 6-hour period of recirculation and oil addition, the K₂CO₃ solution in the reservoir chamber (30) had an opaque aspect and the presence of mineral oil was visible on the surface. It was necessary to wait for a decantation period of 68 hours to obtain a completely clear and transparent K₂CO₃ solution in the reservoir (30). At this time, the oil floating on the surface was collected and weighed using an oil selective absorbent material. The weight of oil collected after 68 hours (after correction for the small amount of K₂CO₃ solution absorbed by the oil selective absorbent) was 35,61 g which represents 7,6% of the total oil that was added to the system by the peristaltic pump.

In the second experiments, the single plate coalescer plate was removed and replaced by a 2-inch diameter tube with the same length as the single plate coalescer plate. The rest of the experiment in terms of set up and K₂CO₃ solution recirculation rate was the same as the first experiment, except for the mineral oil addition rate that was slightly lower at 1 g/min (instead of 1,3 g/min in the first experiment). The experiment was carried out for 6 hours during which 360 g of mineral oil was added at the bottom of the electrolytic cell (10). At the same time, mineral oil was collected at lithium metal outlet (29). After the 6-hour period of recirculation and oil addition, the K₂CO₃ solution in the reservoir (30) had an opaque aspect and the presence of mineral oil on the surface was very visible. After the 68 hours decantation period, the K₂CO₃ solution in the reservoir (30) was still opaque (contrary to the first experiment with the coalescer plate in which the solution was completely clear). At this time, the oil floating on the surface was collected and weighed using an oil selective absorbent material. The weight of oil collected after 68 hours (after correction for the small amount of K₂CO₃ solution absorbed by the oil selective absorbent) was 66,26 g which represents 18,4% of the total oil that was added by the peristaltic pump to the system. It was necessary to wait for 120 hours of decantation to obtain a clear K₂CO₃ solution in the reservoir (30) and another 6,87 g of oil was collected bringing the total amount of oil not collected by the separation chamber (20) oil to 73,15 g which represents 20,29% of the total added oil by the peristaltic pump in the experiment.

As it may be seen, the use of a simple liquid-liquid thin film coalescer has allowed to significantly decrease the percentage of oil not collected in the quiet zone of the separation chamber (20) as it decreased from 20,29% to 7,6% in spite of the fact that the amount of oil added in the first experiment was higher (1,3 g/min compared to 1,0 g/min). The efficacy of the coalescer can also be seen from the time needed to get a completely transparent solution in the reservoir (30) that decreased from 120 hours to 68 hours after the installation of the coalescer plate. It should be noted that the density ratio of LiCl—KCl eutectic (1.64 g/cm³) to molten Li (0,490 g/cm³) is 3,35: 1 at 450° C. and when compared to the case of the 47% K₂CO₃ solution and mineral oil at 20° C. it is of 1,74: 1. The higher ratio in the case of molten Li in the eutectic may result in even better separation efficacies than the one obtained in this example.

### Example 5

5,066 kg of a LiCl—KCl eutectic was prepared by mixing 2,295 kg of LiCl and 2,771 kg of KCl powders. Then, 100 g of 99,5% purity Li₂O powder was well mixed with the LiCl—KCl salt. The mixture was placed in a stainless-steel cylindrical chlorination reactor equipped with a 99,5% alumina lining covering the walls and the bottom of the stainless-steel. The reactor has an internal diameter of 100 mm and a total height of 813 mm. The reactor cover was equipped with a ¼ inch tube Ar inlet that was extended all the way to the bottom of the reactor, a stainless-steel thermocouple, a gas sparger consisting of a ½ inch stainless-steel closed end tube with several 1 mm gas outlet holes at the end of the tube and a ½ inch gas outlet. A Grafoil disc was used as a gasket to seal the reactor. The reactor containing the mixture was placed in a furnace and heated overnight under an Ar atmosphere to 300° C. to eliminate any residual water, especially from the LiCl. The temperature was then raised to 400° C. to melt the mixture and obtain the typical 45,3% LiCl and 54,7% KCl liquid eutectic used in Li production electrolytic cells. The molten salt had a total height of 380 mm in the reactor. Samples of the salt were taken from the top 120 mm of the liquid by the introduction of a 4 stainless-steel rod (previously heated to 105° C. to eliminate any residual moisture). Around 3 g of solidified salt was taken at each sampling. Each sample was collected in a glass vial filled with Ar for its transfer to analysis. Then, the sample was quickly grounded into a homogeneous powder and precisely weighed (0,2 to 2 g depending on the residual concentration of Li₂O). Samples were dissolved in ultrapure water and titrated using a certified 0,01 N HCl solution to determine the residual amount of Li₂O (which is titrated against HCl as LiOH, once dissolved in water). It was established that the intensity of the agitation created by the Ar bubbles had an influence on the concentration of Li₂O measured in the top 120 mm of the reactor. However, even when bubbling Ar at rates of up to 5 I/min, the highest Li₂O concentration measured was 1,72% compared to 1,92% expected by adding 100 g of 99,5% Li₂O to 5066 g of LiCl—KCl. In the experiments, Cl₂ gas (99.5%) was bubbled through the sparger at a flow rate of 3 l/min along with 2 l/min of Ar that was bubbled through the Ar bubbler to keep the Li₂O particles in suspension. In this experiment, the first sample was taken after 30 minutes of Cl₂ bubbling and the residual L₂O concentration was 0.04%, representing 97,7% of conversion. The chlorination was continued for another 10 minutes to reach Li₂O concentration of 0,005% corresponding to 99,7% conversion. The last sample for this experiment was taken 10 minutes later for a total of 50 minutes of chlorination with no change in the Li₂O conversion which remained at 99,7%.

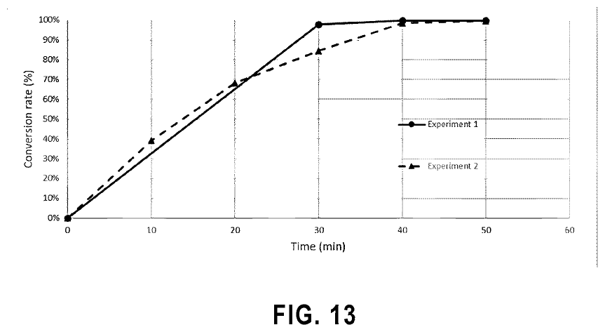

The second experiment was carried out by adding 100 g of Li₂O to the mixture obtained at the end of chlorination experiment 1. For this, 100 g of Li₂O was mixed with 282 g of KCl (to make up for the conversion of Li₂O into LiCl in the first experiment and balance the LiCL: KCl ratio) and 30 g of KCl—LiCl mixture (to make up for sampling losses). The measured concentration of initial Li₂O in the top 120 mm of the reactor mixture was 1,46% instead of the expected 1,72% (99,5 g of Li₂O in 5768 g of mixture). This lower initial proportion is most likely related to the addition of the powder mix into the reactor resulting in a Li₂O partial deposition on the reactor walls over the liquid surface. As for the conditions in experiment 1, the chlorination in experiment 2 was carried out at 3 l/min of Cl₂ through the chlorine sparger and 2 l/min of Ar through the argon bubbler. This time, samples were taken every 10 minutes for a total of 50 minutes of chlorination. The results for both chlorination experiments are shown in FIG. 13. The conversion rate obtained after 50 minutes is 99,4% with a very low residual Li₂O concentration of 0,009%.

These results demonstrate the feasibility of having a continuous addition of Li₂O as a Li precursor and its conversion into LiCl at a very practical rate and very low residual concentrations of Li₂O. It should be noted that using Li₂O as a Li precursor has an important advantage over Li₂CO₃ because a 100% conversion is not needed since, contrary to Li₂CO₃, Li₂O does not react with the Li metal.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
Published European Patent Publication No. 107 521
Published French Patent Application No. 2,532,332
Published French Patent Application No. 2,560,221
U.S. Pat. No. 1,501,756;
U.S. Pat. No. 2,968,526;
US 2013/0001097A1;
U.S. Pat. No. 3,085,967;
U.S. Pat. No. 3,344,049;
U.S. Pat. No. 3,560,263;
U.S. Pat. No. 3,962,064
U.S. Pat. No. 4,139,428;
U.S. Pat. No. 4,200,686;
U.S. Pat. No. 4,405,416;
U.S. Pat. No. 4,533,442;
U.S. Pat. No. 4,617,098;
U.S. Pat. No. 4,724,055;
U.S. Pat. No. 4,740,279;
U.S. Pat. No. 4,980,136;
U.S. Pat. No. 4,988,417; and
WO 2020/210913.
Thermal Properties of LiCl—KCl Molten Salt for Nuclear Waste Separation, Lithium properties and interactions (1978).
Jeppson et al., Lithium Leterature Review: Lithium's properties and interactions. Hanford Engineering Development Laboratory, April 1978.

What is claimed is:

1. An apparatus for producing lithium metal by electrolysis, the apparatus comprising:
a liquid-liquid separator and
a diaphragmless electrolytic cell equipped with:
an anode and a cathode immersed in an electrolysis medium comprising molten LiCl,
a gaseous chlorine outlet located at the top of the cell, and
a Li metal/electrolysis medium mixture outlet adjacent to a surface level of the electrolysis medium in the cell, wherein said mixture outlet is in fluid connection with the liquid-liquid separator to allow passage of a mixture of the electrolysis medium and lithium metal produced by the electrolytic cell into the liquid-liquid separator,
wherein said liquid-liquid separator comprises at least one film coalescer or at least one centrifugal separator for separating the lithium metal produced by the electrolytic cell from the electrolysis medium.

2-7. (canceled)

8. The apparatus of claim 1, wherein the cell further comprises an electrolyte medium inlet towards the base of the cell.

9. The apparatus of claim 1, further comprising an electrolysis medium reservoir and a first conduit fluidly connecting the base of the reservoir to the base of the cell.

10. (canceled)

11. The apparatus of claim 9, further comprising a chlorine bubbler in the reservoir.

12-13. (canceled)

14. The apparatus of claim 1, further comprising a collection tank for collecting a stream of liquid comprising Li metal produced by the liquid-liquid separator.

15. The apparatus of claim 14, wherein the collection tank is located under the liquid-liquid separator.

16-17. (canceled)

18. The apparatus of claim 1, wherein the liquid-liquid separator (and the collection tank if present) are enclosed within a separation chamber.

19. The apparatus of claim 18, wherein the liquid-liquid separator is located between, and immediately adjacent to, the electrolysis medium reservoir and the electrolytic cell.

20. The apparatus of claim 1, further comprising:
a chlorination reactor for the chlorination of Li₂O into LiCl or a LiCl—Li₂O mixture, wherein the chlorination reactor is equipped with a chlorine gas inlet, an oxygen gas outlet, a Li₂O inlet, a LiCl/LiCl—Li₂O mixture outlet, and a heating element, and
a fifth conduit connecting the LiCl/LiCl—Li₂O mixture outlet of the chlorination reactor either to the LiCl/LiCl precursor inlet of the reservoir or to the electrolyte medium inlet of the cell.

21. (canceled)

22. The apparatus of claim 1, further comprising:
a dehydration reactor for the production of Li₂O from LiOH, wherein the dehydration reactor is equipped with a water vapor outlet, a LiOH inlet, a Li₂O outlet, and a heating element and/or a vacuum pump, and
a seventh conduit connecting the Li₂O outlet of the dehydration reactor to the Li₂O inlet of the chlorination reactor, to the LiCl/LiCl precursor inlet of the reservoir or to the electrolyte medium inlet of the cell.

23. The apparatus of claim 1, further comprising:
a decarbonation reactor for the production of Li₂O from Li₂CO₃, wherein the decarbonation reactor is equipped with a CO₂ gas outlet, a Li₂CO₃ inlet, Li₂O outlet, and a heating element and/or a vacuum pump, and
an eighth conduit connecting the Li₂O outlet of the decarbonation reactor to the Li₂O inlet of the chlorination reactor, to the LiCl/LiCl precursor inlet of the reservoir or to the electrolyte medium inlet of the cell.

24. A method for producing lithium, the method comprising:
a) electrolyzing an electrolysis medium comprising molten LiCl in a diaphragmless electrolytic cell,
b) collecting a mixture of lithium metal and electrolysis medium from said cell, and
c) coalescing or separating lithium metal from said mixture using a liquid-liquid separator, wherein said liquid-liquid separator comprises at least one film coalescer or at least one centrifugal separator.

25-29. (canceled)

30. The method of claim 24, further comprising the step of feeding molten LiCl, a precursor thereof, or a mixture thereof to the cell, and, if a precursor is fed, allowing chlorine gas produced by the cell to chlorinate the precursor thus yielding molten LiCl.

31-33. (canceled)

34. The method of claim 30, further comprising the step of producing molten LiCl from a LiCl precursor in the reservoir.

35-36. (canceled)

37. The method of claim 30, further comprising the step of producing LiCl or a LiCl—Li₂O mixture by chlorination of lithium oxide and then adding the LiCl or LiCl—Li₂O mixture to the reservoir or to the cell.

38. The method of claim 30, further comprising the step of producing Li₂O by dehydration of lithium hydroxide or by decarbonation of lithium carbonate.

39. The method of claim 24, further comprising the step of collecting a stream of liquid produced by the liquid-liquid separator, said stream comprising Li metal and the electrolysis medium, and allowing decantation of the stream into a phase of Li metal over a phase of electrolysis medium.

40. (canceled)

41. The method of claim 24, further comprising the step of using heat from the cell to heat the separator.

42. A method for producing lithium metal from Li₂O, the method comprising:
1) feeding Li₂O, LiCl produced from Li₂O, or a mixture thereof to an electrolytic cell, said electrolytic cell comprising an anode, a cathode and an electrolysis medium comprising molten LiCl; and
2) electrolyzing the molten LiCl in said electrolytic cell to produce Li metal and chlorine gas.

43. The method of claim 42, wherein Li₂O is fed to the cell at step 1) and wherein the chlorine gas produced at step 2) is allowed to react with the Li₂O to produce LiCl, which is then electrolyzed at step 2) to produce Li metal.

44. The method of claim 42, further comprising chlorinating Li₂O to produce LiCl, and then feeding the LiCl produced from Li₂O, with or without unreacted Li₂O, to the cell at step 1).

45-50. (canceled)
